(19) United States
(12) Patent Application Publication
(10) Pub. No.: US 2009/0185064 A1
(43) Pub. Date: Jul. 23, 2009

(54) IMAGE-PICKUP APPARATUS AND DISPLAY CONTROLLING METHOD FOR IMAGE-PICKUP APPARATUS

(75) Inventor: Junichi Maniwa, Komae-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/356,957

(22) Filed: Jan. 21, 2009

(30) Foreign Application Priority Data
Jan. 22, 2008 (JP) 2008-011685

(51) Int. Cl. H04N 5/225

(52) U.S. Cl. 348/333.11; 348/E05.024

(57) ABSTRACT

The image-pickup apparatus includes an image-pickup element photoelectrically converting an object image, an image generating unit configured to generate a first image by using an output from the image-pickup element, a focus controller configured to perform focus control of an image-pickup optical system, and an enlarging processing unit configured to enlarge a partial area including a specific object in the first image to generate a second image larger than the partial area. A display controller configured to cause a display state of a monitor to shift from a state where the first image is displayed on the monitor to a state where the second image is displayed on the monitor together with the first image, in response to acquisition of an in-focus state of the image-pickup optical system for the specific object by the focus control.

### BACKGROUND OF THE INVENTION

The present invention relates to an image-pickup apparatus which has a function of detecting an object from an image (image data) generated by using an image-pickup element and a function of displaying an enlarged image of a partial area of the image including the object.

Users using image-pickup apparatuses such as digital cameras often check a composition for image pickup or a focus state through an image displayed on a display provided on a back face of the image-pickup apparatus. Such image-pickup apparatuses have a function of notifying the user of whether or not an in-focus state has been acquired by changing a display color of a focus frame displayed on the display in response to an operation of a release button.

However, in the method for notifying the user of whether or not the in-focus state has been acquired by changing the display color of the focus frame, a screen of the display is difficult to be seen outdoors, which may make it impossible to distinguish the display color of the focus frame

Further, miniaturization of the image-pickup apparatus limits the size of the display provided on its back face, which makes it difficult for the user to check in detail, only through a small image displayed on the display, a focus state for a specific object in that image.

Japanese Patent Laid-Open Nos. 2003-207713 and 2005-62469 disclose image-pickup apparatuses which display an enlarged image of a partial area of an image displayed on a display to facilitate checking of a focus state for a specific object.

However, in the image-pickup apparatus disclosed in Japanese Patent Laid-Open No. 2003-207713, the enlarged display is carried out according to a user's instruction operation of focus checking. Thus, the user has to operate a focus checking switch when wishing to check a focus state.

The image-pickup apparatus disclosed in Japanese Patent Laid-Open No. 2005-62469, an enlarged image of a face of the object is displayed in response to an operation of a release button. Thus, checking of a focus state is difficult if the object is not a human.

### BRIEF SUMMARY OF THE INVENTION

The present invention provides an image-pickup apparatus which enables a user to easily determine whether or not an in-focus state has been acquired, and to easily check an actual focus state in a state where an in-focus determination has been made.

The present invention provides as an aspect thereof an image-pickup apparatus which includes an image-pickup element photoelectrically converting an object image, an image generating unit configured to generate a first image by using an output from the image-pickup element, a focus controller configured to perform focus control of an image-pickup optical system, and an enlarging processing unit configured to enlarge a partial area including a specific object in the first image to generate a second image larger than the partial area. Further, the apparatus includes a display controller configured to cause a display state of a monitor to shift from a state where the first image is displayed on the monitor to a state where the second image is displayed on the monitor together with the first image, in response to acquisition of an in-focus state of the image-pickup optical system for the specific object by the focus control.

The present invention provides as another aspect thereof a display controlling method of an image-pickup apparatus which includes an image-pickup element photoelectrically converting an object image. The method includes a step of generating a first image by using an output from the image-pickup element, a step of performing focus control of an image-pickup optical system, and a step of enlarging a partial area including a specific object in the first image to generate a second image larger than the partial area. Further, the method includes a step of causing a display state of a monitor to shift from a state where the first image is displayed on the monitor to a state where the second image is displayed on the monitor together with the first image, in response to acquisition of an in-focus state of the image-pickup optical system for the specific object by the focus control.

Other aspects of the present invention will be apparent from the embodiments described below with reference to the drawings.

### BRIEF DESCRIPTION OF THE DRAWINGS

FIG. 1 is a block diagram showing the configuration of a digital camera that is an embodiment of the present invention.

FIG. 2 is an external view of the camera of the embodiment.

FIG. 3 is a flowchart showing operations of the camera of the embodiment.

FIG. 4 is a flowchart showing AF frame setting processing in the camera of the embodiment.

FIG. 5 is a flowchart showing in-focus display processing in the camera of the embodiment.

FIG. 6 is a view showing an example of a face frame displayed on a monitor image in the camera of the embodiment.

FIG. 7 shows an example of an AF fame displayed on the monitor image in the camera of the embodiment.

FIG. 8 shows an example of another AF frame set on the monitor image in the camera of the embodiment.

FIG. 9 shows an example of displaying an enlarged face image superimposed on the monitor image in the camera of the embodiment.

FIG. 10 shows an example of displaying an enlarged object image superimposed on the monitor image in the camera of the embodiment.

FIG. 11 shows an example of displaying an enlarged object image in a window separate from that of the monitor image in the camera of the embodiment.

### DETAILED DESCRIPTION OF THE EMBODIMENTS

An exemplary embodiment of the present invention will be described below with reference to the accompanied drawings.

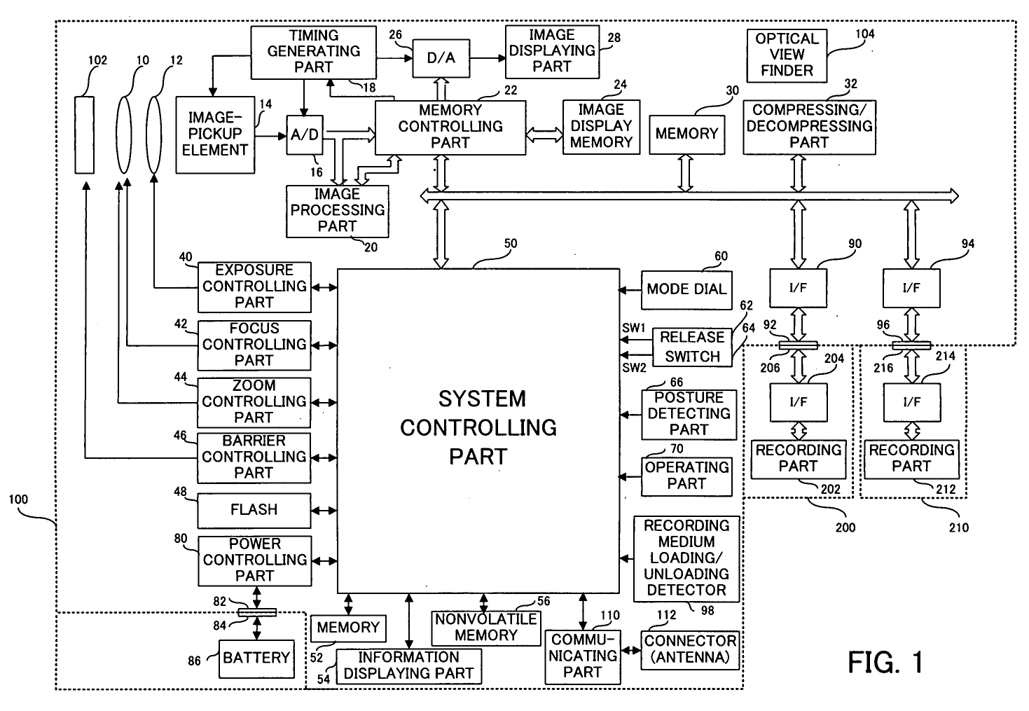

FIG. 1 shows the configuration of a digital camera serving as an image-pickup apparatus which is an embodiment of the present invention.

In FIG. 1, reference numeral 100 denotes a digital camera (hereinafter referred to as a camera). In the camera 100, reference numeral 10 denotes an image-pickup lens serving as an image-pickup optical system, and reference numeral 12 denotes a shutter including an aperture stop function.

Reference numeral 14 denotes an image-pickup element such as a CCD sensor or a CMOS sensor which photoelectrically converts an optical image (object image) to output an electric signal corresponding to the optical image. Reference numeral 16 denotes an A/D converter converting an analog signal output from the image-pickup element 14 into a digital signal.

Reference numeral 18 denotes a timing generating part supplying a clock signal to the image-pickup element 14, the A/D converter 16, and a D/A converter 26. The timing generating part 18 is controlled by a memory controlling part (memory controller) 22 and a system controlling part (system controller) 50, which will be described below.

Reference numeral 20 denotes an image processing part (image generating unit) which performs various image processing operations such as pixel interpolation processing, color conversion processing and AWB (auto white balance) processing for a digital image-pickup signal from the A/D converter 16 or the memory controlling part 22 to generate image data.

The image processing part 20 performs predetermined calculation processing by using the generated image data. The system controlling part 50 controls an exposure controlling part 40, a focus controlling part (focus controller) 42, and a flash 48, based on the calculation results. Thus, AF (auto focus) processing, AE (auto exposure) processing, and EF (electric flash) processing in a through-the-lens (TTL) method are performed. The image processing part 20 further performs predetermined calculation processing by using the generated image data, and thus AWB processing in the TTL method based on the calculation result.

The memory controlling part 22 controls the A/D converter 16, the timing generating part 18, the image processing part 20, an image display memory 24, the D/A converter 26, a memory 30, and a compressing/decompressing part 32.

The image data from the image processing part 20 or the digital image-pickup signal from the A/D converter 16 is written in the image display memory 24 or the memory 30 via the memory controlling part 22.

Reference numeral 28 denotes an image displaying part (monitor) which includes an LCD. Display image data (hereinafter referred to as a monitor image) written in the image display memory 24 is sent to the image displaying part 28 via the D/A converter 26 to be displayed on the image displaying part 28. The monitor image may be sent to a display device provided outside the camera.

Each of the image data generated by the image processing part 20 based on the output from the image-pickup element 14 and the monitor image displayed on the image displaying part 28 corresponding to the image data is a first image.

The memory 30 stores a generated still image or a moving image. The memory 30 is used as a work area of the system controlling part 50.

The compressing/decompressing part 32 compresses and decompresses the image data through ADCT (adaptive discrete cosine transformation). The compressing/decompressing part 32 reads an image stored in the memory 30 to perform compression or decompression processing, and writes data after the processing again in the memory 30.

Reference numeral 40 denotes an exposure controlling part which controls the shutter 12, which has a flash adjusting function associated with the flash 48.

Reference numeral 42 denotes a focus controlling part which performs auto focus control (AF processing) of the image-pickup lens 10 together with the system controlling part 50. The AF processing will be described in detail below. The AF processing enables acquisition of an in-focus state of the image-pickup lens 10 for an object which is a focusing target.

Reference numeral 44 denotes a zoom controlling part which controls zooming of the image-pickup lens 10.

Reference numeral 46 denotes a barrier controlling part which controls an operation of a lens barrier 102. The flash 48 emits illumination light to an object, and has a function of projecting AF assist light and the above-described flash adjusting function.

The exposure controlling part 40 and the focus controlling part 42 are controlled by using the TTL method. In other words, the system controlling part 50 controls the exposure controlling part 40 and the focus controlling part 42 based on the calculation results using the image data generated by the image processing part 20. The system controlling part 50 constitutes a focus controlling part with the focus controlling part 42. The system controlling part 50 controls the entire operations of the camera 100 in addition to the exposure controlling part 40 and the focus controlling part 42.

The system controlling part 50 further functions as a face detecting part (object detecting part) with the image processing part 20, the system controlling part 50 performing face detection processing for detecting a face portion of the object (human) as a face area from the image data generated by the image processing part 20. After detecting the face area from the image data, the system controlling part 50 generates face information including a position of the face area, a size thereof and a face certainty.

The system controlling part 50 functions as a display controlling part to control display of the monitor image or display of an enlarged image described below on the image displaying part 28.

Reference numeral 52 denotes a memory which stores data such as constants, variables or computer programs for operations of the system controlling part 50.

Reference numeral 54 denotes an information displaying part which outputs information indicating an operated state of the camera 100 or a message by using characters, images or voices. The information displaying part 54 includes a liquid crystal display element and a speaker. The information displaying part 54 displays part of information as viewfinder images through an optical viewfinder 104.

Reference numeral 56 denotes a nonvolatile memory such as an EEPROM capable of electrically recording and erasing data.

Reference numeral 60 denotes a mode dial which is operated by a user to switch operation modes such as image-pickup modes (a still image pickup mode and a moving image pickup mode) and a replay mode.

Reference numeral 62 denotes an image-pickup preparation switch (SW1) which is turned ON by a first stroke operation (half-pressing operation: first operation) of a shutter button (release button) as an operating part to start an image-pickup preparation operation including the AE processing based on a photometry result and the AF processing.

Reference numeral 64 denotes an image-pickup recording switch (SW2) which is turned ON by a second stroke operation (full-pressing operation: second operation) of the shutter button to start an image-pickup recording operation. The image-pickup recording operation includes an opening/closing operation of the shutter 12, an operation of generating image data by the image processing part 20 based on the output (image-pickup signal) from the image-pickup element 14, and an operation of writing the image data in the memory 30 via the memory controlling part 22. The image-pickup recording operation further includes an operation of reading the image data from the memory 30 and an operation of compressing the read image data by the compressing/decompressing part 32 for recording the compressed image data in a recording medium 200 or 210. The image-pickup operation may be referred to as a recording image obtaining operation.

Reference numeral 66 denotes a posture detecting part which includes a tilt sensor. The posture detecting part 66 detects a posture (horizontal position or longitudinal position) of the camera 100.

Reference numeral 70 denotes an operating part which includes various buttons and a touch panel. The operating part 70 is operated by the user to display a menu screen for selecting functions of the camera 100 and performing various settings, and to determine menu items.

Reference numeral 80 denotes a power controlling part which includes a battery detecting part for detecting a battery remaining amount, a DC-DC converter for converting a power supply voltage from the battery into a predetermined operation voltage, and a switch for switching parts to be energized.

Reference numeral 86 denotes a battery which is a primary battery such as an alkaline battery or a lithium battery, or a secondary battery such as a NiMH battery or a Li-ion battery. Reference numerals 82 and 84 denote connectors for electrically connecting the battery 86 with the camera 100.

Reference numerals 90 and 94 denote interfaces for communication with the recording media 200 and 201. Reference numerals 92 and 96 denote connectors which are connected to the recording media 200 and 210.

Reference numeral 98 denotes a recording medium loading/unloading detector which detects whether or not the recording media 200 and 210 are connected to the connectors 92 and 96.

Reference numeral 110 denotes a communicating part which has a communication function such as RS232C, USB, IEEE1394, or wireless communication.

Reference numeral 112 denotes a connector for connecting other devices to the camera 100 via the communicating part 110. In the case of performing wireless communication, an antenna is connected to the connector 112.

The recording media 200 and 210 respectively include interfaces 204 and 214 for communication with the camera 100, and connectors 206 and 216 for electrically connecting the camera 100 and the interfaces 204 and 214. The compressed image data or audio data which are output from the camera 100 are written in recording parts 202 and 212. The recording parts 202 and 212 are constituted by semiconductor memories or optical disks.

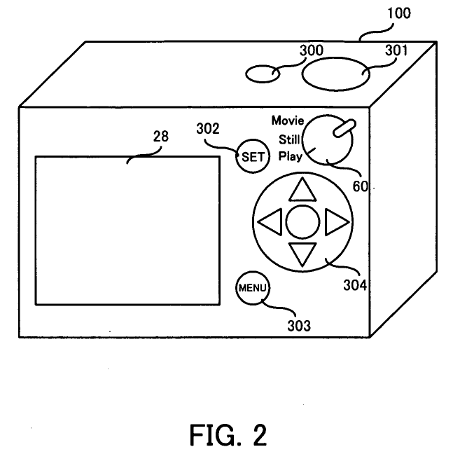

FIG. 2 shows an external view of the camera 100 configured as above when viewed from the backside. In FIG. 2, reference numeral 300 denotes a power button for turning ON/OFF the camera 100. Reference numeral 60 denotes the above-described mode dial, and reference numeral 301 denotes the above-described shutter button. The image displaying part 28 is disposed on the back face of the camera 100.

Reference numerals 302, 303 and 304 respectively denote a set button, a menu button, and a cross button which are included in the operating part 70. Operations of these buttons 302, 303 and 304 can change various settings of the camera 100, and can provide instructions in the replay mode for changing replayed still images and for starting and stopping replay of a recorded moving image.

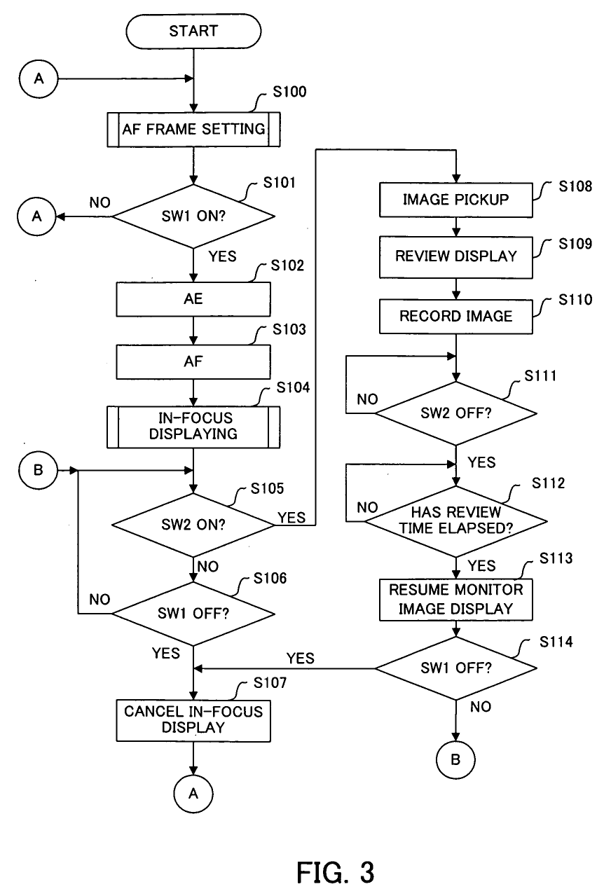

Next, operations of the camera 100 will be described with reference to a flowchart shown in FIG. 3. When an ON-operation of the power button 300 is performed to turn the camera 100 on, the system controlling part 50 starts processing.

First, at Step S100, the system controlling part 50 detects an object from a monitor image (image data generated by the image processing part 20, which corresponds to a first image) displayed on the image displaying part 28 according to an AF frame mode currently set. The system controlling part 50 sets an AF frame to be used for the AF processing or the AE processing, based on information of the detected object. The system controlling part 50 performs AF frame setting processing for displaying the AF frame superimposed on the monitor image.

In the AF mode, the user can arbitrarily set the AF frame through the menu screen displayed on the image displaying part 28 by operating the menu button 303 or an AF frame mode setting button (not shown) included in the operating part 70. The AF frame mode includes a “center mode” that sets one frame disposed in the center of the screen as the AF frame, and an “active mode” that enables the user to move one AF frame to an arbitrary position in the screen by operating the cross button 304. The AF frame mode further includes an “AiAF mode” that sets nine AF frame candidates on the screen and automatically switches the AF frame to be used according to an object, and a “face priority mode” that sets, when detecting a face of an object, the AF frame to a position corresponding to the detected face.

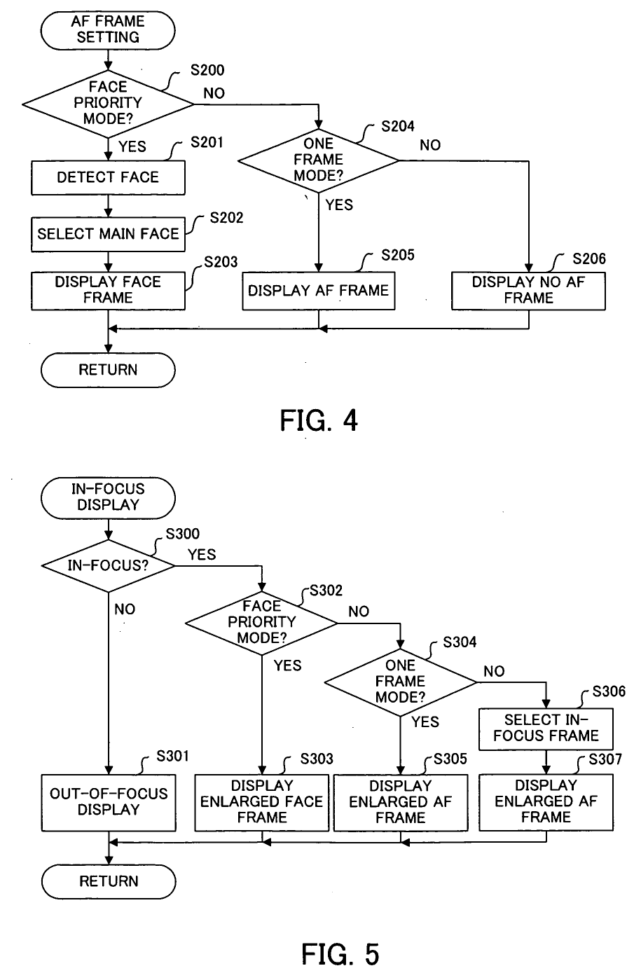

The AF frame setting processing executed at Step S100 will be described in detail with reference to a flowchart shown in FIG. 4.

When the AF frame setting processing is started, the system controlling part 50 determines at Step S200 whether or not the AF frame mode is the face priority mode. If the AF frame mode is the face priority mode, the system controlling part 50 executes at Step S201 face detection processing for detecting a face of an object from the monitor image. In the face detection processing, the system controlling part 50 detects one or more faces from the monitor image generated by the image processing part 20, and generates face information including the position and size of the each face area and the face certainty for each detected face, and the number of the detected faces. The system controlling part 50 then records the face information in the memory 30.

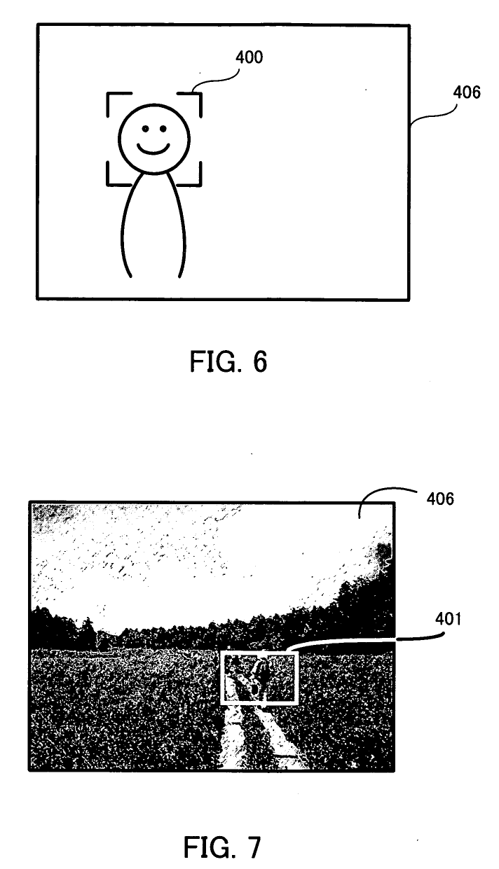

Next, at Step S202, the system controlling part 50 executes main face selection processing for selecting a face to be set as a main object from the one or more detected faces, and setting the face as a “main face”. In the main face selection processing, the system controlling part 50 selects a face to be set as the main face from the one or more detected faces based on the face information recorded in the memory 30, and records a current position of the main face in the memory 30. At Step S203, as shown as a display example in FIG. 6, the system controlling part 50 executes face frame display processing for displaying a face frame 400 indicating an area which includes the main face selected at Step S202 so that the face frame 400 is superimposed on a monitor image 406 displayed on the image displaying part 28. The face frame 400 corresponds to the AF frame in the face priority mode. Then, the system controlling part 50 ends the AF frame setting processing.

The user can change the main face selected by the main face selection processing to another detected face. In this case, the face after the change becomes the main face, and the main face before the change is no longer the main face.

On the other hand, if the AF frame mode is not the face priority mode at Step S200, the system controlling part 50 determines at Step S204 whether or not the AF frame mode is a one frame mode such as the center mode and the active mode. If the AF frame mode is the one frame mode, the system controlling part 50 executes at Step S205 AF frame display processing for displaying an AF frame 401 superimposed on the center of the monitor image 406 or a position therein set by the user as shown as a display example in FIG. 7. Then, the system controlling part 50 ends the AF frame setting processing.

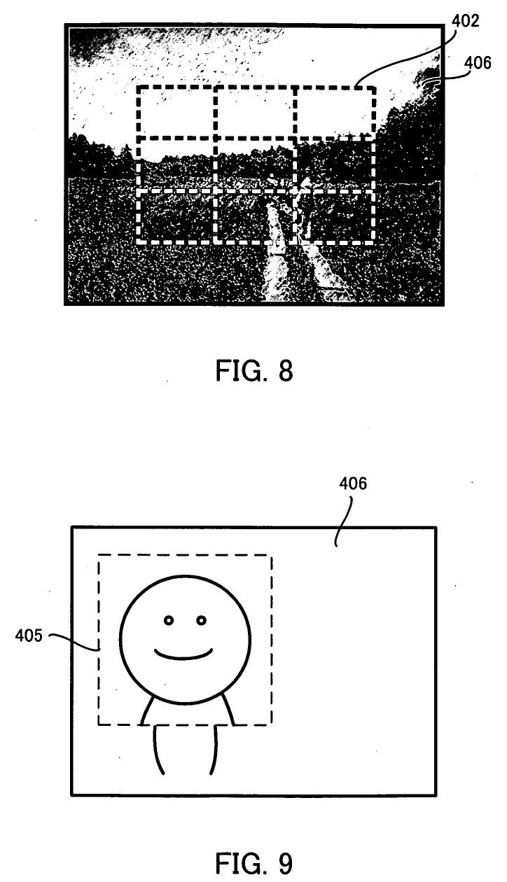

If the AF frame mode is not the one frame mode at Step S204, in other words, the AF frame mode is the AiAF mode, the system controlling part 50 sets at Step S206 plural AF frames 402 on the monitor image 406 as s shown as a display example in FIG. 8. However, display of many AF frames superimposed on the monitor image makes it difficult to view the monitor image. Thus, the system controlling part 50 ends the AF frame setting processing without displaying any AF frame 402 (dotted lines in FIG. 8 indicate the AF frame 402 which are not displayed).

When the AF frame setting processing at Step S100 is ended, the system controlling part 50 determines at Step S101 in FIG. 3 whether or not the image-pickup preparation switch SW1 is turned ON by the first stroke operation of the shutter button 301. If the image-pickup preparation switch SW1 is ON, the system controlling part 50 proceeds to Step S102. If the image-pickup preparation switch SW1 is OFF, the system controlling part 50 returns to Step S100 to repeat the AF frame setting processing.

At Step S102, the system controlling part 50 executes the AE processing by using the exposure controlling part 40 and the image processing part 20. In this case, if the face frame has been set as the AF frame at Step S100, the system controlling part 50 sets an aperture value and a shutter speed so that brightness of an image area in the face frame will be appropriate. If no face frame has been set as the AF frame at Step S100, the system controlling part 50 sets an aperture value and a shutter speed so that brightness of the entire image will be appropriate.

When the AE processing is ended, the system controlling part 50 executes the AF processing at Step S103. In the AF processing, the system controlling part 50 sequentially obtains image data generated by the image processing part 20 while driving a focus lens (not shown) included in the image-pickup lens 10 by a predetermined amount via the focus controlling part 42. Then, the system controlling part 50 executes band pass filter processing for data included in the AF frame set at Step S100 in the obtained image data to generate an AF signal (AF evaluation value signal), and calculates a focus lens position (peak position) where the generated AF signal becomes the maximum.

The system controlling part 50 sets the peak position thus calculated as an in-focus position, and moves the focus lens to the in-focus position via the focus controlling part 42. If the peak position has not been calculated, the system controlling part 50 moves the focus lens to a predetermined position. Thus, the system controlling part 50 ends the AF processing.

After the completion of the AF processing, the system controlling part 50 executes at Step S104 in-focus display processing for displaying whether or not an in-focus state has been acquired by the AF processing.

The in-focus display processing (display control method) will be described below with reference to a flowchart shown in FIG. 5. When the in-focus display processing is started, the system controlling part 50 determines at Step S300 whether or not an in-focus state has been acquired (or whether or not it is an out-of-focus state) by the AF processing at Step S103.

If the in-focus state has been acquired (the in-focus determination has been made), the system controlling part 50 determines at Step S302 whether or not the AF frame mode is the face priority mode. If the AF frame mode is the face priority mode, the system controlling part 50 as an enlarging processing unit executes at Step S303 enlarged face frame display processing.

In the enlarged face frame display processing, the system controlling part 50 enlarges a predetermined area including the face frame 400 shown in FIG. 6, that is, a partial area including a face (face for which the in-focus state has been acquired) as a specific object detected by the face detection processing in the monitor image to generate an enlarged face image (second image). The predetermined area (partial area) may be an area coinciding with the face frame 400, or an area slightly larger or smaller than the face frame 400. The same is applied to a predetermined area including the AF frame, which will be described below.

As shown as a display example in FIG. 9, the system controlling part 50 then displays the enlarged face image superimposed on the monitor image 406 on the image displaying part 28. Thus, the system controlling part 50 ends the in-focus display processing.

On the other hand, if the AF frame mode is not the face priority mode at Step S302, the system controlling part 50 determines at Step S304 whether or not the AF frame mode is the one frame mode. If the AF frame mode is the one frame mode, the system controlling part 50 executes at Step S305 enlarged AF frame display processing.

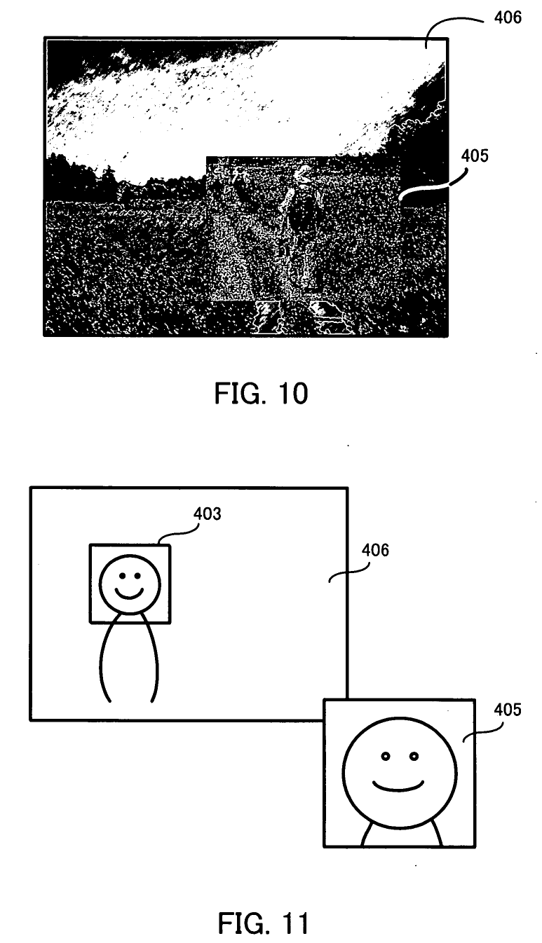

In the enlarged AF frame display processing, the system controlling part 50 as the enlarging processing part enlarges a predetermined area including the AF frame 401 shown in FIG. 7, that is, a partial area including a specific object for which the in-focus state has been acquired in the monitor image to generate an enlarged object image (second image). Then, as shown as a display example in FIG. 10, the system controlling part 50 displays the enlarged object image superimposed on the monitor image 406 on the image displaying part 28. Thus, the system controlling part 50 ends the in-focus display processing.

When generating the enlarged object image, the system controlling part 50 may set the AF frame for the specific object detected by the face detection processing and then enlarge a predetermined area corresponding to the AF frame. That is, the area an enlarging processing part executes at Step S303 enlarged face frame display processing.

In other words, the area where the enlarged face frame display processing is performed at Step S303 may be a partial area corresponding to a detected face as a specific object, or may be a partial area corresponding to an AF frame set based on a detection result of the specific object.

If the AF frame mode is not the one frame mode at Step S304, in other words, the AF frame mode is the AIAF mode, the system controlling part 50 proceeds to Step S306. At Step S306, the system controlling part 50 selects an AF frame for which the in-focus state has been acquired among the nine AF frame candidates shown in FIG. 8 as an in-focus frame from the result of the AF processing of Step S103.

At Step S307, the system controlling part 50 executes the enlarged AF frame display processing. In the enlarged AF frame display processing, the system controlling part 50 enlarges a predetermined area including the in-focus frame, that is, a partial area including a specific object for which the in-focus state has been acquired in the monitor image to generate an enlarged object image (second image). Then, as shown as a display example in FIG. 10, the system controlling part 50 displays the enlarged object image superimposed on the monitor image 406 on the image displaying part 28. Thus, the system controlling part 50 ends the in-focus display processing.

The above-described in-focus display processing enlarges and displays, when the AF result is the in-focus state, the predetermined area including the AF frame in the in-focus state (partial area including the specific object for which the in-focus state has been acquired in the monitor image). This makes it possible to easily notify the user of the in-focus state. Further, the enlarged display is automatically performed in response to acquisition of the in-focus state. Therefore, the user can easily check an actual focus state (in-focus or slightly out of focus) for the specific object for which the in-focus state has been acquired by the AF processing, without any complex operation by the user.

After the in-focus display processing is ended, the system controlling part 50 determines at Steps S105 and S106 states of the image-pickup recording switch SW2 and the image-pickup preparation switch SW1.

While the first stroke operation of the shutter button 301 is maintained (while the OFF-state of the switch SW2 and the ON-state of the switch SW1 are continued), the system controlling part 50 continuously displays the enlarged face image or the enlarged object image superimposed on the monitor image. Thus, the user can more easily check the actual focus state of the specific object for which the in-focus state has been acquired by the AF processing. If the face priority mode is selected, the enlarged face of the object is continuously displayed. Therefore, the user can arbitrarily select an image pickup timing while checking an expression of the face.

When the second stroke operation of the shutter button 301 is performed to turn the image-pickup recording switch SW2 ON at Step S105, the system controlling part 50 proceeds to Step S108. When the first stroke operation of the shutter button 301 is released to turn the image-pickup preparation switch SW1 OFF at Step S106, the system controlling part 50 proceeds to Step S107. At Step S107, the system controlling part 50 cancels the in-focus display, and then returns to Step S100. Thus, the enlarged display on the monitor image is canceled.

At Step S108, the system controlling part 50 exposes the image-pickup element 14 using the aperture value and the shutter speed set in the AE processing at Step S102 in the in-focus state acquired by the AF processing at Step S103, and causes the image processing part 20 to generate a recording image.

Specifically, the system controlling part 50 drives the shutter 12 through the exposure controlling part 40 to expose the image-pickup element 14. After completion of the exposure, an analog signal output from the image-pickup element 14 is converted into a digital signal by the A/D converter 16, and image data is generated from the digital signal by the image processing part 20. The image data is written in the memory 30 through the memory controlling part 22. Further, for the image data written in the memory 30 is read through the memory controlling part 22, various image processing operations such as AWB processing are performed at the image processing part 20, and then the image data is compressed by the compressing/decompressing part 32. The image data after these processing operations is written as a final recording image in the memory 30.

Next, at Step S109, the system controlling part 50 starts processing (review display processing) for displaying the image data written in the memory 30 at Step S108 on the image displaying part 28 for a predetermined review display time.

AT Step S110, the system controlling part 50 executes image recording processing for writing the image data written in the memory 30 at Step S108 in the recording medium 200 or 210.

At Step S111, the system controlling part 50 determines whether or not the image-pickup recording switch SW2 is OFF. If the image-pickup recording switch SW2 is ON, the system controlling part 50 repeats the determination. If the image-pickup recording switch SW2 is OFF, the system controlling part 50 proceeds to Step S112 to determine whether or not the review display time has elapsed.

If the review display time has elapsed, the system controlling part 50 proceeds to Step S113 to resume the display of the monitor image on the image displaying part 28. At the time of resuming the display of the monitor image, the enlarged display on the monitor image is continued. On the other hand, if the review display time has not elapsed, the system controlling part 50 repeats the determination. Thus, while the second stroke operation of the shutter button 301 is performed, the review display is continued.

After resuming the display of the monitor image at Step S113, the system controlling part 50 determines at Step S114 whether or not the image-pickup preparation switch SW1 is OFF. If the image-pickup preparation switch SW1 is ON, the system controlling part 50 returns to Step S105. On the other hand, if the image-pickup preparation switch SW1 is OFF, the system controlling part 50 proceeds to Step S107 to cancel the enlarged display (in-focus display), and then returns to Step S100.

According to the embodiment, the monitor image is displayed without displaying any enlarged image until the in-focus state is acquired by the focus control. Then, in response to the acquisition of the in-focus state, the enlarged image of the partial area including the specific object for which the in-focus state has been acquired in the monitor image is displayed together with the monitor image. In other words, the acquisition of the in-focus state for the specific object by the AF processing causes the partial area including the specific object in the monitor image to be automatically enlarged and displayed. Thus, the user can easily determine whether or not the in-focus state has been acquired, and can easily check the actual focus state for the specific object.

The display of the enlarged image together with the monitor image makes it possible to cause the user to recognize what partial area of the monitor image is enlarged and displayed more easily as compared with a case of displaying only the enlarged image. In short, it can prevent the user from not understanding the composition of an image-pickup region which is understood by the monitor image.

As described above, according to the embodiment, in response to the acquisition of the in-focus state for the specific object by the focus control, the partial area including the specific object is enlarged and displayed. Thus, the user can determine whether or not the in-focus state has been acquired more easily as compared with a conventional image-pickup apparatus which notifies the user of the in-focus state by changing a display color of the focus frame. Moreover, the enlarged display is automatically performed in response to the acquisition of the in-focus state. Therefore, as compared with a conventional image-pickup apparatus which requires an operation of a focus checking switch, the image-pickup apparatus of the embodiment enables easier checking of an actual (detailed) focus state in the in-focus state acquired by the focus control.

While the present invention has been described with reference to an exemplary embodiment, it is to be understood that the invention is not limited to the disclosed exemplary embodiment. The scope of the following claims is to be accorded the broadest interpretation so as to encompass all modifications, equivalent structures and functions.

For example, in the above embodiment, the description was made of the display control method which displays the enlarged image superimposed on the monitor image as shown in FIGS. 9 and 10. However, as shown in FIG. 11, the enlarged image 405 may be displayed as a window image separate from the monitor image 406. In this case, a display color of a face frame 403 in the in-focus state may be changed, or the face frame 403 may be flashed on the monitor image 406.

Further, in the above embodiment, the description was made of the case where only one enlarged image is displayed. However, plural enlarged images may be displayed.

Moreover, in the above embodiment, the description was made of a lens-integrated image-pickup apparatus. However, the present invention can be applied to an image-pickup apparatus such as a lens-interchangeable single-lens reflex digital camera.

This application claims the benefit of Japanese Patent Application No. 2008-011685, filed on Jan. 22, 2008, which is hereby incorporated by reference herein in its entirety.

What is claimed is:

1. An image-pickup apparatus comprising:
an image-pickup element photoelectrically converting an object image;
an image generating unit configured to generate a first image by using an output from the image-pickup element;
a focus controller configured to perform focus control of an image-pickup optical system;
an enlarging processing unit configured to enlarge a partial area including a specific object in the first image to generate a second image larger than the partial area; and
a display controller configured to cause a display state of a monitor to shift from a state where the first image is displayed on the monitor to a state where the second image is displayed on the monitor together with the first image, in response to acquisition of an in-focus state of the image-pickup optical system for the specific object by the focus control.

2. An image-pickup apparatus according to claim 1,
wherein the specific object is a face of a human, and
wherein the image-pickup apparatus further comprising a face detecting part configured to detect the face from the first image.

3. An image-pickup apparatus according to claim 1, further comprising:
an operating part configured to be capable of performing a first operation for instructing the focus control and a second operation for instructing record of a recording image generated by using the image-pickup element,
wherein the display controller continues display of the second image while the first operation is performed.

4. An image-pickup apparatus according to claim 1,
wherein the display controller is configured to cause the monitor to display the second image superimposed on the first image.

5. An image-pickup apparatus according to claim 1,
wherein the display controller is configured to cause the monitor to display the second image as a window image separate from the first image.

6. A display controlling method of an image-pickup apparatus which includes an image-pickup element photoelectrically converting an object image, the method comprising the steps of:
generating a first image by using an output from the image-pickup element;
performing focus control of an image-pickup optical system;
enlarging a partial area including a specific object in the first image to generate a second image larger than the partial area; and
causing a display state of a monitor to shift from a state where the first image is displayed on the monitor to a state where the second image is displayed on the monitor together with the first image, in response to acquisition of an in-focus state of the image-pickup optical system for the specific object by the focus control.
